(19) United States
(12) Patent Application Publication
(10) Pub. No.: US 2025/0182242 A1
(43) Pub. Date: Jun. 5, 2025

(54) CONVOLUTIONAL NEURAL NETW ORK (CNN) FILTER FOR SUPER-RESOLUTION WITH REFERENCE PICTURE RESAMPLING (RPR) FUNCTIONALITY

(71) Applicant: GUANGDONG OPPO MOBILE TELECOMMUNICATIONS CORP., LTD., Dongguan (CN)

(72) Inventors: Cheolkon JUNG, Dongguan (CN); Shimin HUANG, Dongguan (CN)

(21) Appl. No.: 19/004,924

(22) Filed: Dec. 30, 2024

Related U.S. Application Data
(63) Continuation of application No. PCT/CN2022/103953, filed on Jul. 5, 2022.

(51) Int. Cl. G06T 3/4046; G06T 3/4053

(52) U.S. Cl. CPC G06T 3/4046; G06T 3/4053

(57) ABSTRACT

A method for video processing includes: receiving an input image; processing the input image by a first convolution layer; processing the input image by MMSDABs; concatenating outputs of the MMSDABs to form a concatenated image; processing the concatenated image by a second convolution layer to form an intermediate image; processing the intermediate image by a third convolutional layer to generate an output image.

### CROSS-REFERENCE TO RELATED APPLICATION

This application is a Continuation Application of International Application No. PCT/CN2022/103953 filed on Jul. 5, 2022, which is incorporated herein by reference in its entirety.

### TECHNICAL FIELD

The present disclosure relates to video compression schemes that can improve video reconstruction performance and efficiency. More specifically, the present disclosure is directed to systems and methods for providing a convolutional neural network filter used for an up-sampling process.

### BACKGROUND

Video coding of high-definition videos has been the focus in the past decade. Although the coding technology has improved, it remains challenging to transmit high-definition videos with limited bandwidth is limited. Approaches coping with this problem include resampling-based video coding, in which (i) an original video is first “down-sampled” before encoding to form an encoded video, (ii) the encoded video is transmitted as bitstream and then decoded it to form a decoded video; and (iii) then the decoded video is “up-sampled” to the same resolution as the original video. For example, Versatile Video Coding (VVC) supports a resampling-based coding scheme (reference picture resampling, RPR), that a temporal prediction between different resolutions is enabled. However, traditional methods do not handle up-sampling process efficiently especially for videos with complicated characteristics. Therefore, it is advantageous to have an improved system and method to address the foregoing needs.

### SUMMARY

The present disclosure is related to systems and methods for video processing.

In a first aspect, a method for video processing is provided, including: receiving an input image; processing the input image by a first convolution layer; processing the input image by multiple Multi-mixed Scale and Depth Information with Attention Blocks (MMSDABs), wherein each of the MMSDABs includes more than two convolution branches sharing convolution parameters; concatenating outputs of the MMSDABs to form a concatenated image; processing the concatenated image by a second convolution layer to form an intermediate image, wherein a second convolution kernel size of the second convolution layer is smaller than a first convolution kernel size of the first convolution layer; and processing the intermediate image by a third convolutional layer and a pixel shuffle layer to generate an output image.

In a second aspect, a system for video processing is provided, including: a processor; and a memory configured to store instructions, when executed by the processor, to: receive an input image; process the input image by a first convolution layer; process the input image by multiple Multi-mixed Scale and Depth Information with Attention Blocks (MMSDABs), wherein each of the MMSDABs includes more than two convolution branches sharing convolution parameters; concatenate outputs of the MMSDABs to form a concatenated image; process the concatenated image by a second convolution layer to form an intermediate image, wherein a second convolution kernel size of the second convolution layer is smaller than a first convolution kernel size of the first convolution layer; process the intermediate image by a third convolutional layer and a pixel shuffle layer; and generate an output image.

In a third aspect, a method for video processing is provided, including: receiving an input image; processing the input image by a “3×3” convolution layer; processing the input image by multiple Multi-mixed Scale and Depth Information with Attention Blocks (MMSDABs), wherein each of the MMSDABs includes more than two convolution branches sharing convolution parameters; concatenating outputs of the MMSDABs to form a concatenated image; processing the concatenated image by a “1×1” convolution layer to form an intermediate image; processing the intermediate image by a third convolutional layer and a pixel shuffle layer; and generating an output image.

### BRIEF DESCRIPTION OF THE DRAWINGS

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings.

FIG. 1 is a schematic diagram illustrating an MMSDANet framework in accordance with one or more implementations of the present disclosure.

FIG. 2 is a schematic diagram illustrating another MMSDANet framework in accordance with one or more implementations of the present disclosure.

FIG. 3 is a schematic diagram illustrating an MMSDAB in accordance with one or more implementations of the present disclosure.

FIGS. 4A-4C are schematic diagrams illustrating convolutional models with an equivalent receptive field in accordance with one or more implementations of the present disclosure.

FIG. 5 is a schematic diagram of a Squeeze and Excitation (SE) attention mechanism in accordance with one or more implementations of the present disclosure.

FIGS. 6A-E and FIGS. 7A-E are images illustrating testing results in accordance with one or more implementations of the present disclosure.

FIG. 8 is a schematic diagram of a wireless communication system in accordance with one or more implementations of the present disclosure.

FIG. 9 is a schematic block diagram of a terminal device in accordance with one or more implementations of the present disclosure.

FIG. 10 is a flowchart of a method in accordance with one or more implementations of the present disclosure.

### DETAILED DESCRIPTION

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

The present disclosure is related to systems and methods for improving image qualities of videos using a neural network for video compression. More particularly, the present disclosure provides a Multi-mixed Scale and Depth Information with Attention Neural Network (MMSDANet) to perform an up-sampling process (it can be called a Super-Resolution (SR) process). Though the following systems and methods are described in relation to video processing, in some embodiments, the systems and methods may be used for other image processing systems and methods. The convolutional neural network (CNN) framework can be trained by deep learning and/or artificial intelligent schemes.

The MMSDANet is a CNN filter for RPR-based SR in VVC. The MMSDANet can be embedded within the VVC codec. The MMSDANet includes Multi-mixed Scale and Depth Information with Attention Blocks (MMSDABs). The MMSDANet is based on residual learning to accelerate network convergence and reduce training complexity. The MMSDANet effectively extracts low-level features in a “U-Net” structure by stacking MMSDABs, and transfers the extracted low-level features to a high-level feature extraction module through U-Net connections. High-level features contain global semantic information, whereas low-level features contain local detail information. The U-Net connections can further reuse low-level features while restoring local details.

More particularly, the MMSDANet adopts residual learning to reduce the network complexity and improve the learning ability. The MMSDAB is designed as a basic block combined with attention mechanism so as to extract multi-scale and depth-wise layer information of image features. Multi-scale information can be extracted by convolution kernels of different sizes, whereas depth-wise layer information can be extracted from different depths of the network. For MMSDAB, sharing parameters of convolutional layers can reduce the number of overall network parameters and thus significantly improve the overall system efficiency.

In some embodiments, the present method can be implemented by a tangible, non-transitory, computer-readable medium having processor instructions stored thereon that, when executed by one or more processors, cause the one or more processors to perform one or more aspects/features of the method described herein. In other embodiments, the present method can be implemented by a system including a computer processor and a non-transitory computer-readable storage medium storing instructions that when executed by the computer processor cause the computer processor to perform one or more actions of the method described herein.

In a first clause, the present application provides a method for video processing, which includes:
receiving an input image;
processing the input image by a first convolution layer;
processing the input image by multiple Multi-mixed Scale and Depth Information with Attention Blocks (MMSDABs), where each of the MMSDABs includes more than two convolution branches sharing convolution parameters;
concatenating outputs of the MMSDABs to form a concatenated image;
processing the concatenated image by a second convolution layer to form an intermediate image, where a second convolution kernel size of the second convolution layer is smaller than a first convolution kernel size of the first convolution layer; and
processing the intermediate image by a third convolutional layer and a pixel shuffle layer to generate an output image.

In a second clause, according to the first clause, the input image is received by a first part of a Multi-mixed Scale and Depth Information with Attention Neural Network (MMSDANet).

In a third clause, according to the second clause, the first convolution layer is a “3×3” convolution layer, and where the first convolution layer is included in the first part of the MMSDANet.

In a fourth clause, according to the third clause, the multiple MMSDABs is included in a second part of the MMSDANet, and where the second part of the MMSDANet includes a concatenation module.

In a fifth clause, according to the first clause, the multiple MMSDABs include 8 MMSDABs.

In a sixth clause, according to the fourth clause, the second convolution layer is an “1×1” convolution layer, and therein the second convolution layer is included in the second part of the MMSDANet.

In a seventh clause, according to the sixth clause, the third convolution layer is a “3×3” convolution layer, and where the third convolution layer is included in a third part of the MMSDANet.

In an eighth clause, according to the first clause, each of the MMSDABs includes a first layer, a second layer, and a third layer.

In a ninth clause, according to the eighth clause, the first layer includes three convolutional layers with different dimensions.

In a tenth clause, according to the eighth clause, the second layer includes one “1×1” convolutional layer and two “3×3” convolutional layers.

In an eleventh clause, according to the eighth clause, the third layer includes a concatenation block, a channel shuffle block, an “1×1” convolution layer, and a Squeeze and Excitation (SE) attention block.

In a twelfth clause, the present application provides a system for video processing, which includes:
a processor; and
a memory configured to store instructions, when executed by the processor, to:
receive an input image;
process the input image by a first convolution layer;
process the input image by multiple Multi-mixed Scale and Depth Information with Attention Blocks (MMSDABs), where each of the MMSDABs includes more than two convolution branches sharing convolution parameters;
concatenate outputs of the MMSDABs to form a concatenated image;
process the concatenated image by a second convolution layer to form an intermediate image, where a second convolution kernel size of the second convolution layer is smaller than a first convolution kernel size of the first convolution layer;
process the intermediate image by a third convolutional layer and a pixel shuffle layer; and
generate an output image.

In a thirteenth clause, according to the twelfth clause, the input image is received by a first part of a Multi-mixed Scale and Depth Information with Attention Neural Network (MMSDANet).

In a fourteenth clause, according to the thirteenth clause, the first convolution layer is a “3×3” convolution layer, and where the first convolution layer is included in the first part of the MMSDANet.

In a fifteenth clause, according to the fourteenth clause, the multiple MMSDABs are included in a second part of the MMSDANet, and where the second part of the MMSDANet includes a concatenation module.

In a sixteenth clause, according to the twelfth clause, the multiple MMSDABs include 8 MMSDABs.

In a seventeenth clause, according to the fifteenth clause, the second convolution layer is a “1×1” convolution layer, therein the second convolution layer is included in the second part of the MMSDANet, where the third convolution layer is a “3×3” convolution layer, and where the third convolution layer is included in a third part of the MMSDANet.

In an eighteenth clause, according to the twelfth clause, each of the MMSDABs includes a first layer, a second layer, and a third layer.

In a nineteenth clause, according to the eighteenth clause, the first layer includes three convolutional layers with different dimensions, where the second layer includes one “1×1” convolutional layer and two “3×3” convolutional layers, and where the third layer includes a concatenation block, a channel shuffle block, a “1×1” convolution layer, and a Squeeze and Excitation (SE) attention block.

In a twentieth clause, the present application provides a method for video processing, which includes:
receiving an input image;
processing the input image by a “3×3” convolution layer;
processing the input image by multiple Multi-mixed Scale and Depth Information with Attention Blocks (MMSDABs), where each of the MMSDABs includes more than two convolution branches sharing convolution parameters;
concatenating outputs of the MMSDABs to form a concatenated image;
processing the concatenated image by a “1×1” convolution layer to form an intermediate image;
processing the intermediate image by a third convolutional layer and a pixel shuffle layer; and
generating an output image.

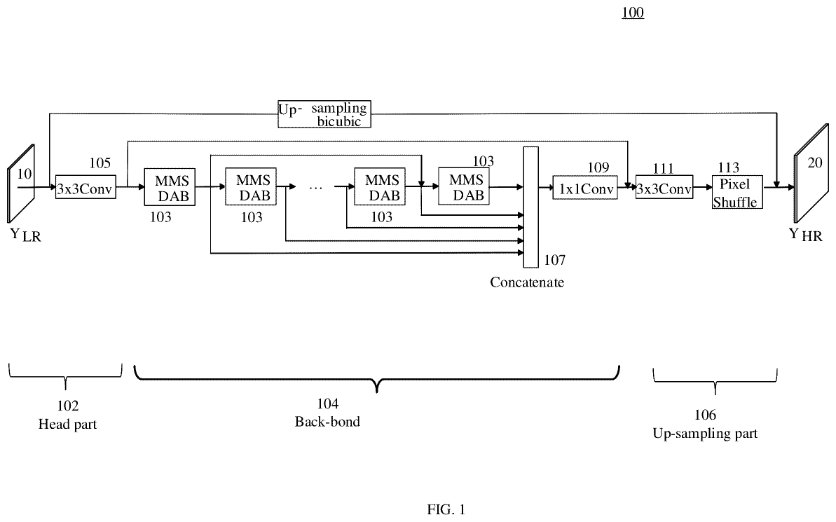

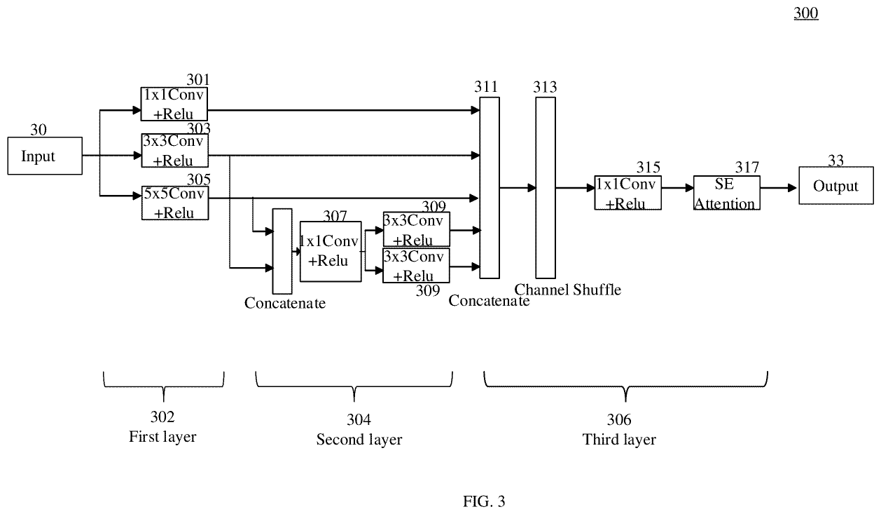

FIG. 1 is a schematic diagram illustrating an MMSDANet 100 in accordance with one or more implementations of the present disclosure. To implement an RPR functionality, a current frame for encoding is first down-sampled to reduce bitstream transmission and then is restored at the decoding end. The current frame is to be up-sampled to its original resolution. The MMSDANet 100 includes an SR neural network to replace a traditional up-sampling algorithm in a traditional RPR configuration. The MMSDANet 100 is a CNN filter with a multi-level mixed scale and depth-wise layer information with an attention mechanism (see. e.g., FIG. 3). The MMSDANet framework 100 uses residual learning to reduce the complexity of network learning so as to improve performance and efficiency.

Residual learning recovers image details well at least because residuals contain these image details. As shown in FIG. 1, the MMSDANet 100 includes multiple MMSDABs 103 to use different convolution kernel sizes and convolution layer depths. The MMSDAB 103 extract multi-scale information and depth information, and then combine with an attention mechanism (see. e.g., FIG. 3) to complete feature extraction. The MMSDANet 100 up-samples an input image 10 to be the same resolution as an output image 20 by interpolation and then enhance the image quality by residual learning.

The MMSDAB 103 is a basic block to extract multi-scale information and convolution depth information of input feature maps. The attention mechanism is then applied to enhance important information and suppress noise. The MMSDAB 103 shared convolutional layers so as to effectively reduce the number of parameters caused by using different sized convolution kernels. When sharing the convolutional layers, layer depth information is also introduced.

As shown in FIG. 1, the MMSDANet 100 includes three parts: a head part 102, a backbone part 104, and an up-sampling part 106. The head part 102 includes a convolutional layer 105, which is used to extract shallow features of the input image 10. The convolutional layer 105 is followed by an ReLU (Rectified Linear Unit) activation function. Using “Y_{LR}” to indicate the input image 10 and “ψ” to show the head part 102, a shallow feature f₀ can be represented as follows:

$${f}_{0} = ψ ( {Y}_{LR} ) \qquad Equation ( 1 )$$

The backbone part 104 includes “M” MMSDABs 103. In some embodiments, “M” can be an integer more than 2. In some embodiments, “M” can be “8.” The backbone part 104 uses f₀ as input, concatenates the outputs of the MMSDABs 103 (at concatenation block 107), and then reduces the number of channels by a “1×1” convolution 109 to get f_{ft} which can then be put in the up-sampling part 106 (or reconstruction part). To make a full use of low-level features, a connection method in “U-Net” is used to add fᵢ and f_{M-i} as the input of ω_{M-i+1}, as shown in the following equations:

$$\begin{matrix}{f}_{M - i + 1} = {ω}_{M - i + 1} ( {f}_{i} + {f}_{M - i} ) & 0 < i < M / 2\end{matrix} \qquad Equation ( 2 )$$

$${f}_{ft} = Conv ( C [ {ω}_{M} , {ω}_{M - 1} , … {ω}_{1} ( {f}_{0} ) ] ) + {f}_{0} \qquad Equation ( 3 )$$

Where ωᵢ represents the “M-th” MMSDAB. “C [·]” represents a channel concatenation process. The channel concatenation process refers to stacking features in a channel dimension. For instance, dimensions of two feature maps can be “BxC1xHxW” and “BxC2xHxW.” After the concatenation process, the dimension becomes “Bx(C1+C2) xHxW.” Parameter “fᵢ” represents the output of the “M-th” MMSDAB.

The up-sampling part 106 includes a convolutional layer 111 and a pixel shuffle process 113. The up-sampling part 106 can be expressed as follows:

$${Y}_{HR} = PS ( Conv ( {f}_{ft} ) ) + {Y}_{LR} \qquad Equation ( 4 )$$

Where Y_{HR} is the upsampled image, PS is the pixel shuffle layer, Conv represents the convolutional layers, and ReLU activation function is not used in the up-sampling part 106.

In some embodiments, in addition to the three parts, the input image 10 can be added to the output of the up-sampling part 106. By this arrangement, the MMSDANet 100 only needs to learn global residual information to enhance the quality of the input image 10. It significantly reduces training difficulty and burden of the MMSDANet 100.

In some embodiments, when the MMSDANet 100 to chroma and luma channels, the backbone part 104 and the up-sampling part 106 can be the same. In such embodiments, the input and the head part 102 of the network can be different.

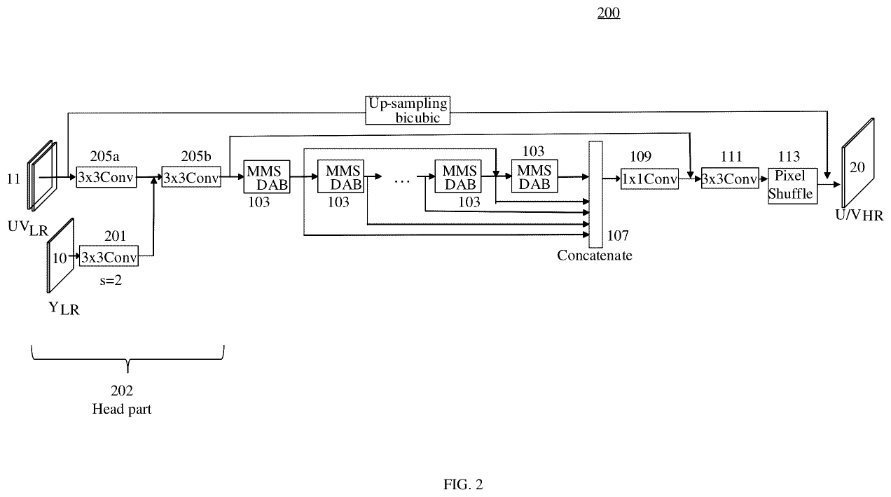

FIG. 2 is a schematic diagram illustrating a MMSDANet framework 200 for chroma channels. Inputs of the MMSDANet framework 200 include three channels, including luminance (or luma) channel Y and chrominance (or chroma) channels U and V. In some embodiments, the chrominance channels (U, V) contain less information and can easily lose key information after compression. Therefore, in designing of the chrominance component network MMSDANet 200, all three channels Y, U, and V are used so as to provide sufficient information. The luma channel Y includes more information than the chroma channels U, V, and thus using the luma channel Y to guide the up-sampling process (i.e., SR process) of the chroma channels U, V would be beneficial.

As shown in FIG. 2, a head part 202 of the MMSDANet 200 includes two 3×3 convolutional layers 205a, 205b. The 3×3 convolutional layer 205a to extract shallow features, whereas the 3×3 convolutional layer 205b is used to extract shallow features after mixing the chroma and luma channels. First, the two channels U and V are concatenated together and go through the 3×3 convolutional layer 205a. Then shallow features are extracted through the convolutional layers 205b.

The size of the guided component Y can be twice of the UV channel, and thus the Y channel needs to be down-sampled first. Accordingly, the head part 202 includes a 3×3 convolution layer 201 with stride 2 for down-sampling. The head part 202 can be expressed as follows:

$${f}_{0} = Conv ( Conv ( C [ {U}_{LR} , {V}_{LR} ] ) + dConv ( {Y}_{LR} ) ) \qquad Equation ( 5 )$$

Where f₀ represents the output of the head part 202, dConv ( ) represents the downsampling convolution, and Conv ( ) represents the normal convolution with stride 1.

As shown in FIGS. 1 and 2, the MMSDABs 103 are basic units of the network 100 and 200. FIG. 3 is a schematic diagram illustrating an MMSDAB 300 in accordance with one or more implementations of the present disclosure. The MMSDAB 300 is designed to extract features from a large receptive field and emphasize important channels by SE (Squeeze and Excitation) attention from the extracted features. It is believed that parallel convolution with different receptive fields is effective when extracting features with various receptive fields. To increase the receptive field and capture multi-scale and depth information, the MMSDAB 300 includes a structure with three layers 302, 304, and 306.

The first layer 302 includes three convolutional layers 301 (1×1), 303 (3×3), and 305 (5×5). The second layer 304 includes a concatenation block, a 1×1 convolutional layer 307 and two 3×3 convolutional layers 309.

The third layer 306 includes four parts: a concatenation block 311, a channel shuffle block 313, a 1×1 convolution layer 315, and an SE attention block 317. In the illustrated embodiments, each of the convolutional layers is followed by an ReLU activation function to improve the performance of the MMSDAB 300. The ReLU activation function has a good nonlinear mapping ability and therefore it can solve gradient disappearance problems in neural networks and expedite network convergence.

An overall process of the MMSDAB 300 can be expressed as follow steps.
First step: Three convolutions (e.g., 301, 303, and 305) with kernel sizes 1×1, 3×3, and 5×5 are used to extract features of different scales of an input image 30.
Second step: Two 3×3 convolutions (e.g., 309) are used to further extract depth and scale information of the input image 30 by combining multi-scale information from the first step. Prior to this step, concatenating the multi-scale information from the first step and use a 1×1 convolution layer (e.g., 307) for dimensionality reduction to reduce the computational cost. Since the input of the second step is the output of the first step, no additional convolution operation is required, and thus the required computational resources are further reduced.
Third step: The outputs of the first two steps are first fused through a concatenation operation (e.g., 311) and a channel shuffle operation (e.g., 313). Then the dimensions of the layers are reduced through a 1×1 convolutional layer (e.g., 315). Finally, the squeeze and excitation (SE) attention block 317 is used to enhance important channel information and suppresses weak channel information. Then an output image 33 can be generated.

Another aspect of the MMSDAB 300 is that it provides an architecture with shared convolution parameters such that it can significantly improve computing efficiency. By taking the depth information of convolutional layers into account while obtaining multiple scale information (e.g., the second layer 304 of the MMSDAB 300) can substantially enhance coding performance and efficiency. Moreover, the number of convolution parameters used in the MMSDAB 300 is significantly fewer than that used in other conventional methods.

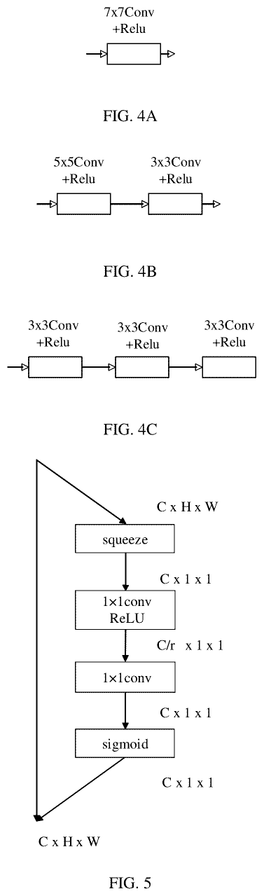

In conventional methods, a typical convolution layer module can include four branches, and each branch independently extracts different scale information without interference one another. As the layer deepens from top to bottom, the required size and number of convolution kernels increase significantly. Such a multi-scale module requires a large number of parameters to support its computing scale information. Compared to conventional methods, the MMSDAB 300 is advantageous at least because: (1) the branches of the MMSDAB 300 are not independent from one another; and (2) large-scale information can be obtained by the convolution layer with small-scale information obtained from an upper layer. As explained below with reference to FIGS. 4A-4C, in convolution operation, the receptive field of a large convolution kernel can be obtained by two or more convolution cascades.

FIGS. 4A-4C are schematic diagrams illustrating convolutional models with an equivalent receptive field in accordance with one or more implementations of the present disclosure. For example, the receptive field of a 7×7 convolution kernel is 7×7, which is equivalent of the receptive field obtained by cascading one 5×5 and 3×3 convolution layers or three 3×3 convolution layers. Therefore, by sharing a small-scale convolution output as an intermediate result of a large-scale convolution, required convolution parameters are greatly reduced.

For example, the dimension of an input feature map can be 64×64×64. For a 7×7 convolution, the number of required parameters would be “7×7×64×64.” For a 3×3 convolution, the number of required parameters would be “3×3×64×64.” For a 5×5 convolution, the number of required parameters would be “5×5×64×64.” For a 1×1 convolution, the number of required parameters would be “1×1×64×64.” As can be seen from the foregoing examples, using the “3×3” convolution and/or the “5×5” convolution to replace the “7×7” convolution can significantly reduce the amount of parameters required.

In some embodiments, the MMSDAB 300 can generate deep feature information. In cascade CNNs, different network depths can produce different feature information. In other words, “shallower” network layers produce low-level information, including rich textures and edges, whereas “deeper” network layers can extract high-level semantic information, such as contours.

After the MMSDAB 300 uses the “1×1” convolution (e.g., 307) to reduce the dimension, the MMSDAB 300 connects two 3×3 convolutions in parallel (e.g., 309), which can obtain both larger scale information and depth feature information. Thus, the entire MMSDAB 300 can extract scale information with deep feature information. Therefore, the whole MMSDAB 300 enables rich-feature extraction capability.

FIG. 5 is a schematic diagram of a Squeeze and Excitation (SE) attention mechanism in accordance with one or more implementations of the present disclosure. To better capture channel information, the MMSDAB 300 uses a SE attention mechanism as shown in FIG. 5. In conventional convolution calculations, each output channel corresponds to a separate convolution kernel, and these convolution kernels are independent of each other, so the output channels do not fully consider the correlation between input channels. To address this issue, the present SE attention mechanism has three steps, namely a “squeeze” step, an “excitation” step, and a “scale” step.
Squeeze: First, a global average pooling on an input feature map is performed to obtain f_{sq}. Each of the learned filters operates with a local receptive field and consequently each unit of the transformation output is unable to exploit contextual information outside of this region. To mitigate this problem, the SE attention mechanism first “squeezes” global spatial information into a channel descriptor. This is achieved by a global average pooling to generate channel-wise statistics.
Excitation: This step is motivated to better obtain the dependency of each channel. Two conditions need to be met: the first condition is that the nonlinear relationship between each channel can be learned, and the second condition is that each channel has an output (e.g., the value cannot be 0). An activation function in the illustrated embodiments can be “sigmoid” instead of the commonly used ReLU. The excitation process is that f_{sg} passes through two fully connected layers to compress and restore the channel. In image processing, to avoid the conversion between matrices and vectors, 1×1 convolution layer is used instead of using a fully connected layer.
Scale: Finally, a dot product is performed between the output after excitation and SE attention.

In some embodiments, CNN uses L1 or L2 loss to make the output gradually close to the ground truth as the network converges. For up-sampling (or SR) tasks, a high-resolution map output by the MMSDANet is required to be consistent with the ground truth. The L1 or L2 loss is a loss function that is compared at the pixel level. The L1 loss calculates the sum of the absolute values of the difference between the output and the ground truth, whereas the L2 loss calculates the sum of the squares of the difference between the output and the ground truth. Although CNN uses L1 or L2 loss to remove blocking artifacts and noise in the input image, it cannot recover textures lost in the input image. In some embodiments, L2 loss is used to train the MMSDANet, and the loss function f(x) can be expressed as follows:

$$f ( x ) = L 2 \qquad Equation ( 6 )$$

L2 loss is convenient for gradient descent. When the error is large, it decreases quickly, and when the error is small, it decreases slowly, which is conducive to convergence.

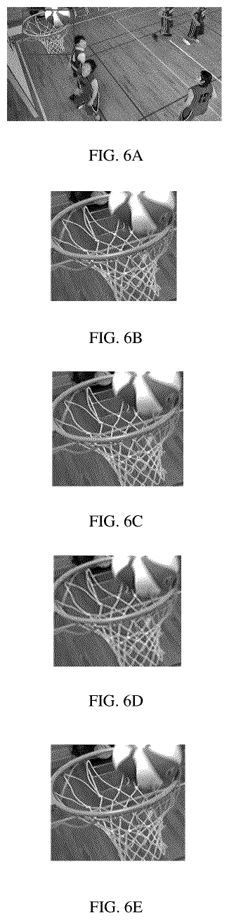

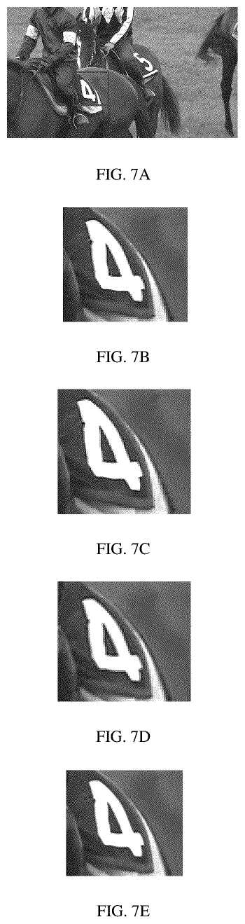

FIGS. 6A-E (i.e., “Basketballs”) and FIGS. 7A-E (i.e., “RHorses”) are images illustrating testing results in accordance with one or more implementations of the present disclosure. Descriptions of the images are as follows: (a) low-resolution image compressed at QP 32 after down-sampling of the original image; (b) uncompressed high-resolution image; (c) high-resolution image compressed at QP 32; (d) high-resolution map of (a) after up-sampling with the RPR process; (e) high-resolution map of (a) after up-sampling with the MMSDANet.

As shown in both FIGS. 6E and 7E, the up-sampling performance by using the MMSDANet is better than the up-sampling using RPR (e.g., FIGS. 6D and 7D). It is obvious that the MMSDANet recovers more details and boundary information than the RPR up-sampling.

Tables 1-4 below shows quantitative measurements of the use of the MMSDANet. The test results under “all intra” (AI) and “random access” (RA) configurations are shown in Tables 1-4. Among them, “shaded areas” represent positive gain and “bolded/underlined” numbers represents negative gain. These tests are all conducted under “CTC.” “VTM-11.0” with new “MCTF” are used as the baseline for tests.

Tables 1 and 2 show the results in comparison with VTM 11.0 RPR anchor. The MMSDANet achieves {−8.16%, −25.32%, −26.30%} and {−6.72%, −26.89%, −28.19%} BD-rate reductions ({Y, Cb, Cr}) under AI and RA configurations, respectively.

Tables 3 and 4 show the results in comparison with VTM 11.0 NNVC-1.0 anchor. The MMSDANet achieves {−8.5%, 18.78%, −12.61%} and {−4.21%, 4.53%, −9.55%} BD-rate reductions ({Y, Cb, Cr}) under RA and AI configurations, respectively.

TABLE 1
Results of the proposed method for AI configurations compared with RPR anchor.

| All Intra Main10 | | | | |
|---|---|---|---|---|
| Over VTM-11.0 + New MCTF (QP 22, 27, 32, 37, 42) | | | | |
| Y | U | V | EncT | DecT |

| | | | | |
|---|---|---|---|---|
| Cass A1 | Tango2 | −3.84% | −19.42% | −22.18% |
| 4K | FoodMarket4 | −3.88% | −11.94% | −14.27% |
| | Campfire | −11.91% | −33.32% | −39.87% |
| Class A2 | CatRobot1 | −9.61% | −27.58% | −28.43% |
| 4K | DaylightRoad2 | −12.40% | −21.74% | −20.44% |
| | ParkRunning3 | −7.31% | −37.89% | −32.58% |
| Class C | BasketballDrill | −36.84% | −38.09% | −44.17% |
| | BQMall | −26.63% | −26.90% | −25.39% |
| | Party Scene | −29.24% | −30.70% | −24.65% |
| | RaceHorses | −32.58% | −41.14% | −37.03% |

| | | | |
|---|---|---|---|
| Average on A1 | −6.54% | −21.56% | −25.44% |
| Average on A2 | −9.77% | −29.07% | −27.15% |
| Average on C | −31.32% | −34.21% | −32.81% |
| Overall | −15.88% | −28.28% | −28.47% |

TABLE 2
Results of the proposed method for RA configurations
compared with RPR anchor.

| | | Random Access Main10 | | | | |
|---|---|---|---|---|---|---|
| | | Over VTM-11.0 + New MCTF (QP 22, 27, 32, 37, 42) | | | | |
| | | Y | U | V | EncT | DecT |
| Cass A1 | Tango2 | −2.13% | −25.15% | −21.55% | | |
| 4K | FoodMarket4 | −2.69% | −12.95% | −15.14% | | |
| | Campfire | −9.02% | −21.69% | −35.82% | | |
| Class A2 | CatRobot1 | −9.10% | −32.85% | −33.57% | | |
| 4K | DaylightRoad2 | −11.68% | −25.11% | −25.48% | | |
| | ParkRunning3 | −5.70% | −45.36% | −37.56% | | |
| Class C | BasketballDrill | −39.74% | −43.46% | −49.10% | | |
| | BQMall | −30.03% | −31.70% | −29.81% | | |
| | Party Scene | −41.37% | −41.21% | −33.13% | | |
| | RaceHorses | −25.60% | −42.43% | −37.75% | | |

| | | | |
|---|---|---|---|
| Average on A1 | −4.61% | −19.93% | −24.17% |
| Average on A2 | −8.82% | −34.44% | −32.20% |
| Average on C | −34.19% | −39.70% | −37.45% |
| Overall | −15.87% | −31.16% | −31.27% |

TABLE 3
Results of the proposed method for AI configurations
compared with NNVC anchor.

| | | All Intra Main10 | | | | |
|---|---|---|---|---|---|---|
| | | Over VTM-11.0 + New MCTF (QP 22, 27, 32, 37, 42) | | | | |
| | | Y | U | V | EncT | DecT |
| Cass A1 | Tango2 | −9.45% | −17.31% | −15.16% | | |
| 4K | FoodMarket4 | −4.48% | −6.65% | −6.73% | | |
| | Campfire | −12.88% | 149.67% | −23.80% | | |
| Class A2 | CatRobot1 | −7.72% | −11.63% | −9.82% | | |
| 4K | DaylightRoad2 | −2.67% | −22.70% | −19.24% | | |
| | ParkRunning3 | −13.80% | 21.27% | −0.90% | | |
| Class C | BasketballDrill | 19.45% | −9.29% | −4.09% | | |
| | BQMall | 48.53% | −27.02% | −28.51% | | |
| | PartyScene | 77.80% | −32.64% | −36.14% | | |
| | RaceHorses | 18.82% | −33.01% | −32.99% | | |

| | | | |
|---|---|---|---|
| Average on A1 | −8.94% | 41.90% | −15.23% |
| Average on A2 | −8.06% | −4.35% | −9.99% |
| Average on C | 41.15% | −25.49% | −25.43% |
| Overall | 8.05% | 4.02% | −16.88% |

TABLE 4
Results of the proposed method for RA configurations
compared with NNVC anchor.

| Random Access Main10 | | | | |
|---|---|---|---|---|
| Over VTM-11.0 + New MCTF (QP 22, 27, 32, 37, 42) | | | | |
| Y | U | V | EncT | DecT |

| | | | | |
|---|---|---|---|---|
| Cass A1 | Tango2 | −7.21% | −25.62% | −15.34% |
| 4K | FoodMarket4 | −6.11% | −9.98% | −11.33% |
| | Campfire | −17.64% | 37.67% | −23.28% |
| Class A2 | CatRobot1 | 3.54% | −11.06% | −3.36% |
| 4K | DaylightRoad2 | 12.81% | −19.84% | −15.21% |
| | ParkRunning3 | −10.65% | 55.99% | 11.25% |
| Class C | BasketballDrill | 54.55% | 17.63% | 20.89% |
| | BQMall | 105.06% | −11.50% | −13.86% |
| | Party Scene | 340.58% | −3.31% | −6.24% |
| | RaceHorses | 36.16% | −12.44% | −11.28% |

| | | | |
|---|---|---|---|
| Average on A1 | −10.32% | 0.69% | −16.65% |
| Average on A2 | 1.90% | 8.36% | −2.44% |
| Average on C | 134.09% | −2.41% | −2.62% |
| Overall | 62.84% | 2.21% | −7.24% |

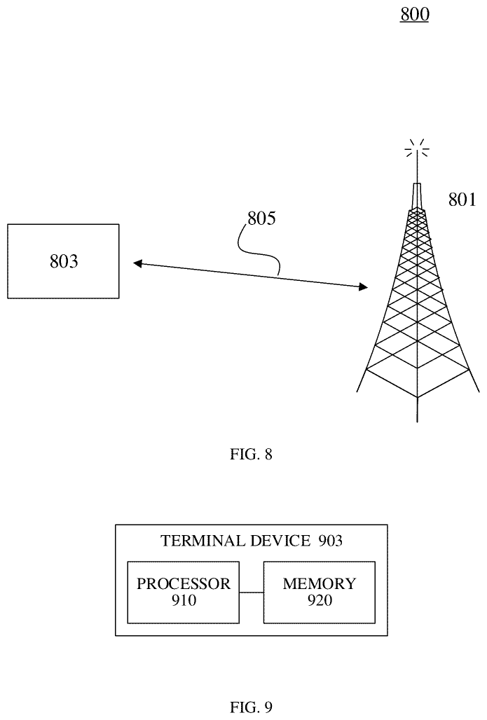

FIG. 8 is a schematic diagram of a wireless communication system 800 in accordance with one or more implementations of the present disclosure. The wireless communication system 800 can implement the MMSDANet framework discussed herein. As shown in FIG. 8, the wireless communications system 800 can include a network device (or base station) 801. Examples of the network device 801 include a base transceiver station (Base Transceiver Station, BTS), a NodeB (NodeB, NB), an evolved Node B (eNB or eNodeB), a Next Generation NodeB (gNB or gNode B), a Wireless Fidelity (Wi-Fi) access point (AP), etc. In some embodiments, the network device 801 can include a relay station, an access point, an in-vehicle device, a wearable device, and the like. The network device 801 can include wireless connection devices for communication networks such as: a Global System for Mobile Communications (GSM) network, a Code Division Multiple Access (CDMA) network, a Wideband CDMA (WCDMA) network, an LTE network, a cloud radio access network (Cloud Radio Access Network, CRAN), an Institute of Electrical and Electronics Engineers (IEEE) 802.11-based network (e.g., a Wi-Fi network), an Internet of Things (IoT) network, a device-to-device (D2D) network, a next-generation network (e.g., a 5G network), a future evolved public land mobile network (Public Land Mobile Network, PLMN), or the like. A 5G system or network can be referred to as a new radio (New Radio, NR) system or network.

In FIG. 8, the wireless communications system 800 also includes a terminal device 803. The terminal device 803 can be an end-user device configured to facilitate wireless communication. The terminal device 803 can be configured to wirelessly connect to the network device 801 (via, e.g., via a wireless channel 805) according to one or more corresponding communication protocols/standards. The terminal device 803 may be mobile or fixed. The terminal device 803 can be a user equipment (UE), an access terminal, a user unit, a user station, a mobile site, a mobile station, a remote station, a remote terminal, a mobile device, a user terminal, a terminal, a wireless communications device, a user agent, or a user apparatus. Examples of the terminal device 803 include a modem, a cellular phone, a smartphone, a cordless phone, a Session Initiation Protocol (SIP) phone, a wireless local loop (WLL) station, a personal digital assistant (PDA), a handheld device having a wireless communication function, a computing device or another processing device connected to a wireless modem, an in-vehicle device, a wearable device, an Internet-of-Things (IoT) device, a device used in a 5G network, a device used in a public land mobile network, or the like. For illustrative purposes, FIG. 8 illustrates only one network device 801 and one terminal device 803 in the wireless communications system 800. However, in some instances, the wireless communications system 800 can include additional network device 801 and/or terminal device 803.

FIG. 9 is a schematic block diagram of a terminal device 903 (e.g., which can implement the methods discussed herein) in accordance with one or more implementations of the present disclosure. As shown, the terminal device 903 includes a processor 910 (e.g., a DSP, a CPU, a GPU, etc.) and a memory 920. The processor 910 can be configured to implement instructions that correspond to the methods discussed herein and/or other aspects of the implementations described above. It should be understood that the processor 910 in the implementations of this technology may be an integrated circuit chip and has a signal processing capability. During implementation, the steps in the foregoing method may be implemented by using an integrated logic circuit of hardware in the processor 910 or an instruction in the form of software. The processor 910 may be a general-purpose processor, a digital signal processor (DSP), an application specific integrated circuit (ASIC), a field programmable gate array (FPGA) or another programmable logic device, a discrete gate or transistor logic device, and a discrete hardware component. The methods, steps, and logic block diagrams disclosed in the implementations of this technology may be implemented or performed. The general-purpose processor 910 may be a microprocessor, or the processor 910 may be alternatively any conventional processor or the like. The steps in the methods disclosed with reference to the implementations of this technology may be directly performed or completed by a decoding processor implemented as hardware or performed or completed by using a combination of hardware and software modules in a decoding processor. The software module may be located at a random-access memory, a flash memory, a read-only memory, a programmable read-only memory or an electrically erasable programmable memory, a register, or another mature storage medium in this field. The storage medium is located at a memory 920, and the processor 910 reads information in the memory 920 and completes the steps in the foregoing methods in combination with the hardware thereof.

It may be understood that the memory 920 in the implementations of this technology may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM) or a flash memory. The volatile memory may be a random-access memory (RAM) and is used as an external cache. For exemplary rather than limitative description, many forms of RAMs can be used, and are, for example, a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synchronous link dynamic random-access memory (SLDRAM), and a direct Rambus random-access memory (DR RAM). It should be noted that the memories in the systems and methods described herein are intended to include, but are not limited to, these memories and memories of any other suitable type. In some embodiments, the memory may be a non-transitory computer-readable storage medium that stores instructions capable of execution by a processor.

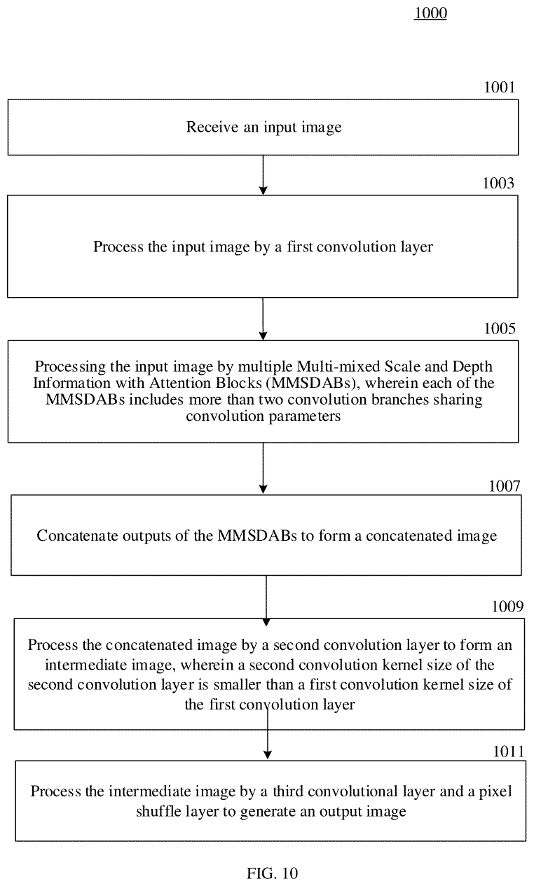

FIG. 10 is a flowchart of a method in accordance with one or more implementations of the present disclosure. The method 1000 can be implemented by a system (such as a system with the MMSDANet discussed herein). The method 1000 is for enhancing image qualities (particularly, for an up-sampling process). The method 1000 includes, at block 1001, receiving an input image.

At block 1003, the method 1000 continues by processing the input image by a first convolution layer. In some embodiments, the first convolution layer is a “3×3” convolution layer and is included in a first part of a Multi-mixed Scale and Depth Information with Attention Neural Network (MMSDANet). Embodiments of the MMSDANet are discussed in detail with reference to FIGS. 1 and 2.

At block 1005, the method 1000 continues by processing the input image by multiple Multi-mixed Scale and Depth Information with Attention Blocks (MMSDABs). Each of the MMSDABs includes more than two convolution branches sharing convolution parameters. In some embodiments, the multiple MMSDABs include 8 MMSDABs. In some embodiments, each of the MMSDABs includes a first layer, a second layer, and a third layer. In some embodiments, the first layer includes three convolutional layers with different dimensions. In some embodiments, the second layer includes one “1×1” convolutional layer and two “3×3” convolutional layers. In some embodiments, the third layer includes a concatenation block, a channel shuffle block, a “1×1” convolution layer, and a Squeeze and Excitation (SE) attention block. Embodiments of the MMSDABs are discussed in detail with reference to FIG. 3. In some embodiments, the multiple MMSDABs is included in a second part of the MMSDANet, and wherein the second part of the MMSDANet includes a concatenation module.

At block 1007, the method 1000 continues by concatenating outputs of the MMSDABs to form a concatenated image. At block 1009, the method 1000 continues by processing the concatenated image by a second convolution layer to form an intermediate image. A second convolution kernel size of the second convolution layer is smaller than a first convolution kernel size of the first convolution layer. In some embodiments, the second convolution layer is a “1×1” convolution layer. At block 1011, the method 1000 continues to process the intermediate image by a third convolutional layer and a pixel shuffle layer to generate an output image. In some embodiments, the third convolution layer is a “3×3” convolution layer, and wherein the third convolution layer is included in a third part of the MMSDANet.

### Additional Considerations

The above Detailed Description of examples of the disclosed technology is not intended to be exhaustive or to limit the disclosed technology to the precise form disclosed above. While examples for the disclosed technology are described above for illustrative purposes, various equivalent modifications are possible within the scope of the described technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative implementations or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

In the Detailed Description, numerous details are set forth to provide a thorough understanding of the presently described technology. In other implementations, the techniques introduced here can be practiced without these details. In other instances, well-known features, such as functions or routines, are not described in detail in order to avoid unnecessarily obscuring the present disclosure. in References this description to “an implementation/embodiment,” “one implementation/embodiment,” or the like mean that a particular feature, structure, material, or characteristic being described is included in at least one implementation of the described technology. Thus, the appearances of such phrases in this specification do not necessarily all refer to the same implementation/embodiment. On the other hand, such references are not necessarily mutually exclusive either. Furthermore, the particular features, structures, materials, or characteristics can be combined in any suitable manner in one or more implementations/embodiments. It is to be understood that the various implementations shown in the figures are merely illustrative representations and are not necessarily drawn to scale.

Several details describing structures or processes that are well-known and often associated with communications systems and subsystems, but that can unnecessarily obscure some significant aspects of the disclosed techniques, are not set forth herein for purposes of clarity. Moreover, although the following disclosure sets forth several implementations of different aspects of the present disclosure, several other implementations can have different configurations or different components than those described in this section. Accordingly, the disclosed techniques can have other implementations with additional elements or without several of the elements described below.

Many implementations or aspects of the technology described herein can take the form of computer- or processor-executable instructions, including routines executed by a programmable computer or processor. Those skilled in the relevant art will appreciate that the described techniques can be practiced on computer or processor systems other than those shown and described below. The techniques described herein can be implemented in a special-purpose computer or data processor that is programmed, configured, or constructed to execute one or more of the computer-executable instructions described below. Accordingly, the terms “computer” and “processor” as generally used herein refer to any data processor. Information handled by these computers and processors can be presented at any suitable display medium. Instructions for executing computer- or processor-executable tasks can be stored in or on any suitable computer-readable medium, including hardware, firmware, or a combination of hardware and firmware. Instructions can be contained in any suitable memory device, including, for example, a flash drive and/or other suitable medium.

The term “and/or” in this specification is only an association relationship for describing the associated objects, and indicates that three relationships may exist, for example, A and/or B may indicate the following three cases: A exists separately, both A and B exist, and B exists separately.

These and other changes can be made to the disclosed technology in light of the above Detailed Description. While the Detailed Description describes certain examples of the disclosed technology, as well as the best mode contemplated, the disclosed technology can be practiced in many ways, no matter how detailed the above description appears in text. Details of the system may vary considerably in its implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the invention is not limited, except as by the appended claims. In general, the terms used in the following claims should not be construed to limit the disclosed technology to the examples disclosed in the specification, unless the above Detailed Description section explicitly defines such terms.

A person of ordinary skill in the art may be aware that, in combination with the examples described in the implementations disclosed in this specification, units and algorithm steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

What is claimed is:

1. A method for video processing, applied to a decoding processor and comprising:
receiving an input image;
processing the input image by a first convolution layer;
processing the input image by multiple Multi-mixed Scale and Depth Information with Attention Blocks (MMSDABs), wherein each of the MMSDABs includes more than two convolution branches sharing convolution parameters;
concatenating outputs of the MMSDABs to form a concatenated image;
processing the concatenated image by a second convolution layer to form an intermediate image, wherein a second convolution kernel size of the second convolution layer is smaller than a first convolution kernel size of the first convolution layer; and
processing the intermediate image by a third convolutional layer and a pixel shuffle layer to generate an output image.

2. The method of claim 1, wherein the input image is received by a first part of a Multi-mixed Scale and Depth Information with Attention Neural Network (MMSDANet).

3. The method of claim 2, wherein the first convolution layer is a “3×3” convolution layer, and wherein the first convolution layer is included in the first part of the MMSDANet.

4. The method of claim 3, wherein the multiple MMSDABs are included in a second part of the MMSDANet, and wherein the second part of the MMSDANet includes a concatenation module.

5. The method of claim 1, wherein the multiple MMSDABs include 8 MMSDABs.

6. The method of claim 4, wherein the second convolution layer is an “1×1” convolution layer, and therein the second convolution layer is included in the second part of the MMSDANet.

7. The method of claim 6, wherein the third convolution layer is a “3×3” convolution layer, and wherein the third convolution layer is included in a third part of the MMSDANet.

8. The method of claim 1, wherein each of the MMSDABs includes a first layer, a second layer, and a third layer.

9. The method of claim 8, wherein the first layer includes three convolutional layers with different dimensions.

10. The method of claim 8, wherein the second layer includes one “1×1” convolutional layer and two “3×3” convolutional layers.

11. The method of claim 8, wherein the third layer includes a concatenation block, a channel shuffle block, an “1×1” convolution layer, and a Squeeze and Excitation (SE) attention block.

12. A system for video processing, the system comprising:
a processor; and
a memory configured to store instructions, when executed by the processor, to:
receive an input image;
process the input image by a first convolution layer;
process the input image by multiple Multi-mixed Scale and Depth Information with Attention Blocks (MMSDABs), wherein each of the MMSDABs includes more than two convolution branches sharing convolution parameters;
concatenate outputs of the MMSDABs to form a concatenated image;
process the concatenated image by a second convolution layer to form an intermediate image, wherein a second convolution kernel size of the second convolution layer is smaller than a first convolution kernel size of the first convolution layer;
process the intermediate image by a third convolutional layer and a pixel shuffle layer; and
generate an output image.

13. The system of claim 12, wherein the input image is received by a first part of a Multi-mixed Scale and Depth Information with Attention Neural Network (MMSDANet).

14. The system of claim 13, wherein the first convolution layer is a “3×3” convolution layer, and wherein the first convolution layer is included in the first part of the MMSDANet.

15. The system of claim 14, wherein the multiple MMSDABs is included in a second part of the MMSDANet, and wherein the second part of the MMSDANet includes a concatenation module.

16. The system of claim 12, wherein the multiple MMSDABs include 8 MMSDABs.

17. The system of claim 15, wherein the second convolution layer is a “1×1” convolution layer, therein the second convolution layer is included in the second part of the MMSDANet, wherein the third convolution layer is a “3×3” convolution layer, and wherein the third convolution layer is included in a third part of the MMSDANet.

18. The system of claim 12, wherein each of the MMSDABs includes a first layer, a second layer, and a third layer.

19. The system of claim 18, wherein the first layer includes three convolutional layers with different dimensions, wherein the second layer includes one “1×1” convolutional layer and two “3×3” convolutional layers, and wherein the third layer includes a concatenation block, a channel shuffle block, a “1×1” convolution layer, and a Squeeze and Excitation (SE) attention block.

20. A method for video processing, applied to a decoding processor, and comprising:
receiving an input image;
processing the input image by a “3×3” convolution layer;
processing the input image by multiple Multi-mixed Scale and Depth Information with Attention Blocks (MMSDABs), wherein each of the MMSDABs includes more than two convolution branches sharing convolution parameters;
concatenating outputs of the MMSDABs to form a concatenated image;
processing the concatenated image by a “1×1” convolution layer to form an intermediate image;
processing the intermediate image by a third convolutional layer and a pixel shuffle layer; and
generating an output image.
